(19) United States
(12) Patent Application Publication
(10) Pub. No.: US 2006/0242665 A1
(43) Pub. Date: Oct. 26, 2006

(54) Interactive television program guide systems with initial channel tuning

(75) Inventors: Robert A. Knee, Lansdale, PA (US); Todd A. Walker, Bixby, OK (US); William L. Thomas, Bixby, OK (US); Charles B. Ammann, Tulsa, OK (US)

Correspondence Address: FISH & NEAVE IP GROUP;ROPES & GRAY LLP, 1251 AVENUE OF THE AMERICAS FL C3, NEW YORK, NY, 10020-1105, US

(73) Assignee: United Video Properties, Inc.

(21) Appl. No.: 11/473,730

(22) Filed: Jun. 22, 2006

Related U.S. Application Data
(62) Division of application No. 09/608,388, filed on Jun. 30, 2000.
(60) Provisional application No. 60/144,700, filed on Jul. 20, 1999.

(51) Int. Cl. H04N 5/50; H04N 5/44; H04N 7/173; H04N 5/445; G06F 3/00

(52) U.S. Cl. 725/38; 725/100; 348/725; 348/734; 348/731

(57) ABSTRACT

A system is provided based on user equipment such as a set-top box or computer with which an interactive television program guide is implemented. The system may gather information on the television viewing and music listening habits of a user and the user's interactions with the program guide. The user may adjust settings in the interactive television program guide. When the user equipment is turned on, the interactive television program guide may automatically tune the user equipment to an appropriate digital music channel or television channel. This channel may be selected based on the user's television viewing habits, music listening habits, the user's interactions with the program guide, or the settings selected by the user. Information on the user's interests may be stored in a history database. The information in the history database may be used to generate television program reminders for the user.

This application claims the benefit of U.S. provisional application No. 60/144,700, filed Jul. 20, 1999.

### BACKGROUND OF THE INVENTION

This invention relates to television systems, and more particularly, to interactive television systems such as interactive television program guide systems that tune to an initial television channel or music channel when turned on based on user interests.

Interactive television program guides are typically implemented on set-top boxes connected to televisions. Such program guides may be used to present screens of interactive television program listings to users.

Program guides may also be used to control which television channels the set-top box tunes to when a user is watching television. For example, a program guide may tune to different television channels in response to channel-changing commands from the user's remote control.

With one current arrangement, when a set-top box is first turned on the program guide tunes the set-top box to the channel that was last being watched when the set-top box was turned off. With another current arrangement, when the set-top box is first turned on the program guide tunes the set-top box to a predetermined channel that was selected by a cable system operator using equipment at a cable system headend. Other techniques exist for controlling the turn-on behavior of the set-top box. For example, the program guide may automatically tune the set-top box to the lowest channel supported by the set-top box.

It is an object of the present invention to provide arrangements for automatically tuning set-top boxes or other user equipment to television or music channels of particular interest to the user when turned on.

If is also an object of the present invention to provide users with reminders about upcoming content based on information stored in a history database based on the user's viewing and listening interests.

### SUMMARY OF THE INVENTION

A system is provided that gathers information on a user's television viewing activities and music listening activities. This information may be used to select a channel to automatically tune to when the user turns on equipment such as a set-top box or the like.

The user's television viewing activities may be monitored by an interactive television program guide. The program guide may maintain a history database containing information on the user's television viewing habits.

Information on the user's television viewing habits may be collected by monitoring which television programs the user watches. Information may also be gathered on the time at which the programs are watched, how long the programs are watched, and the channels on which the programs are watched.

The user may be provided with an opportunity to establish customized guidelines or settings to assist the program guide in determining what channel to tune to when the set-top box or other equipment is turned on.

Other types of user activities may be monitored, such as the user's interactions with the interactive television program guide. Information on these activities may also be stored in the history database.

When the user turns on the set-top box or other equipment on which the interactive television program guide is implemented, the program guide may automatically tune the set-top box to an appropriate channel. The channel to tune to may be determined based on the information on the user's viewing habits and other activities that is stored in the history database and based on the settings established by the user. The television channel that the program guide tunes to may also be influenced by the current time.

The listening activities of the user may be monitored by the interactive television program guide. Information on the listening activities of the user and the user's music interests may be stored in the history database. The songs the user listens to, user-selected music settings, and the user's interactions with the program guide may be used to determine which music channel to tune the user's equipment to when the user turns on the equipment.

Program reminders may be provided to the user based on the information stored in the history database. The program reminders may be provided as pop-up overlays presented on top of the currently-displayed content on the user equipment or may be provided by e-mail.

Further features of the invention, its nature and various advantages will be more apparent from the accompanying drawings and the following detailed description of the preferred embodiments.

### BRIEF DESCRIPTION OF THE DRAWINGS

FIG. 1 is a diagram of an illustrative interactive television system in accordance with the present invention.

FIG. 2 is a diagram of illustrative user television equipment in accordance with the present invention.

FIG. 3 is a diagram of additional illustrative user television equipment in accordance with the present invention.

FIG. 4 is a diagram of an illustrative remote control in accordance with the present invention.

FIG. 5 is a diagram of illustrative user computer equipment in accordance with the present invention.

FIG. 6 is a generalized diagram of illustrative user equipment in accordance with the present invention.

FIG. 7 shows an illustrative menu screen in accordance with the present invention.

FIG. 8 shows an illustrative program guide screen in accordance with the present invention.

FIG. 9 is a flow chart of illustrative steps involved in maintaining a history database of a user's television viewing activities in accordance with the present invention.

FIG. 10 is a flow chart of illustrative steps involved in automatically tuning user equipment to a television channel that is selected based on the user's monitored television viewing activities in accordance with the present invention.

FIG. 11 shows an illustrative turn-on settings screen that may be provided by an interactive program guide to allow a user to adjust program guide settings related to selecting an appropriate turn-on channel in accordance with the present invention.

FIG. 12 is a flow chart of illustrative steps involved in automatically tuning user equipment to a television channel that is selected based on user-adjusted program guide settings in accordance with the present invention.

FIG. 13 is an illustrative program guide screen containing sports-related program listings in accordance with the present invention.

FIG. 14 is a flow chart of illustrative steps involved in automatically tuning user equipment to a television channel that is selected based on a user's interactions with an interactive television program guide in accordance with the present invention.

FIG. 15 shows an illustrative music information region that may be displayed by the program guide for a digital music channel in accordance with the present invention.

FIG. 16 shows an illustrative digital music channel information screen that may be displayed by the program guide for a digital music channel in accordance with the present invention.

FIG. 17 is a flow chart of illustrative steps involved in monitoring the user's listening habits in accordance with the present invention.

FIG. 18 is a flow chart of illustrative steps involved in determining the user's interests and selecting and using a turn-on digital music channel based on those interests in accordance with the present invention.

FIG. 19 shows an illustrative reminder overlay that may be presented by the interactive television program guide based on information in a history database in accordance with the present invention.

FIG. 20 is a flow chart of illustrative steps involved in providing reminders to the user based on the user's interests in accordance with the present invention.

### DETAILED DESCRIPTION OF THE PREFERRED EMBODIMENTS

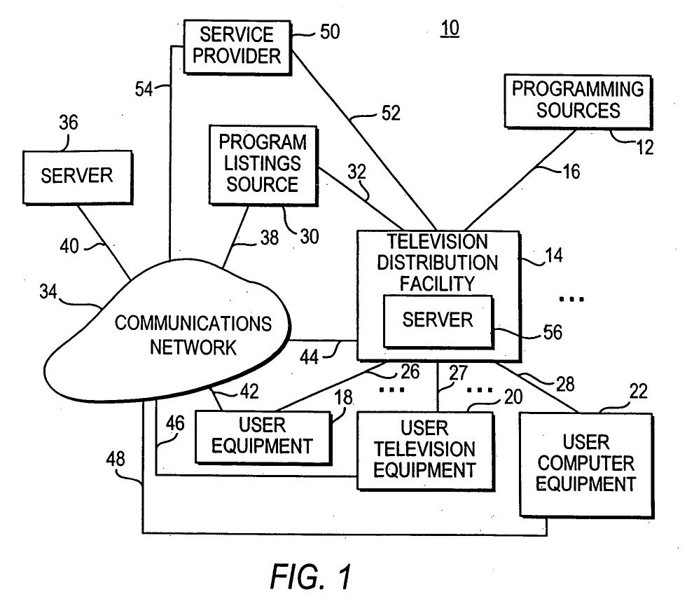

An illustrative interactive television system 10 in accordance with the present invention is shown in FIG. 1. Television programming and digital music may be provided from programming sources 12 to television distribution facilities such as television distribution facility 14 using communications path 16. Programming sources 12 may be any suitable sources of television and music programming, such as television and music production studios, etc.

Television distribution facility 14 may be a cable system headend, a satellite television distribution facility, a television broadcast facility, or any other suitable facility for distributing television and music programming to users. There are typically numerous television distribution facilities 14 in system 10, but only one is shown in FIG. 1 to avoid overcomplicating the drawings.

Communications path 16 may be a satellite path, a fiber-optic path, a cable path, or any other suitable wired or wireless communications paths or combinations of such paths.

Television distribution facility 14 may be connected to various user equipment devices 18. Such user equipment 18 may, for example, be located in the homes of users. User equipment 18 may include user television equipment 20 or user computer equipment 22.

The user equipment may receive television and music programming and other information from television distribution facility 14 over communications paths such as communications paths 26, 27, and 28. The user equipment may also transmit signals to television distribution facility 14 over paths 26, 27, and 28. Paths 26, 27, and 28 may be cables or other wired connections, free-space connections (e.g., for broadcast or other wireless signals), satellite links, etc.

Program listings source 30 may be used to provide the user with television program schedule information such as scheduled broadcast times, titles, channels, ratings information (e.g., parental ratings and critic's ratings), detailed title descriptions, genre or category information (e.g., sports, news, movies, etc.), information on actors and actresses, running times, etc.

Program listings source 30 may provide program schedule information to television distribution facility 14 over communications path 32 for distribution to the associated user equipment over paths 26, 27, and 28. Communications path 32 may be any suitable communications path such as a satellite communications path or other wireless path, a fiber-optic or other wired communications path, a path that supports Internet communications, a combination of such paths, etc.

User equipment devices such as user television equipment and personal computers may use the program schedule information to display program listings and information on digital music for the user. An interactive television program guide application or other suitable application may be used to display such information on the user's display.

An on-line program guide may be provided by a server connected to communications network 34 such as server 36. Server 36 may receive program schedule information from program listings source 30 via communications path 38, communications network 34, and communications path 40. Paths 38 and 40 may be satellite paths, fiber-optic paths, wired paths, etc. Communications network 34 may be any suitable communications network, such as the Internet, the public switched telephone network, a packet-based network, etc.

User equipment 18 may access the on-line program guide via communications path 42, which may be any suitable communications path such as a wired path, a cable path, fiber-optic path, satellite path, a combination of such paths, or any other suitable path. User equipment 18 may also access the on-line program guide via communications path 26, television distribution facility 14, and communications path 44. For example, a cable modem or the like may be used by user equipment 18 to communicate with television distribution facility 14. Television distribution facility 14 may communicate with communications network 34 over any suitable path 44, such as a wired path, a cable path, fiber-optic path, satellite path, a combination of such paths, etc.

User equipment such as user television equipment 20 and user computer equipment 22 may access the on-line program guide using similar arrangements. User television equipment 20 may access the on-line program guide using communications path 46 or using path 27, television distribution facility 14, and path 44. User computer equipment 22 may access the on-line program guide using communications path 48 or using path 28, television distribution facility 14, and path 44. Paths 46 and 48 may be any suitable paths, such as wired paths, cable paths, fiber-optic paths, satellite paths, a combination of such paths, etc.

Interactive television applications other than program guide applications may use service providers such as service provider 50. For example, a home shopping service may be supported by a service provider such as service provider 50 that has sales representatives, order fulfillment facilities, account maintenance facilities, and other equipment for supporting interactive home shopping features. A home shopping application that is implemented using the user equipment may be used to access the service provider to provide these features to the user. The user equipment may access service provider 50 via television distribution facility 14 and communications path 52 or via communications network 34 and communications path 54. Communications paths such as paths 52 and 54 may be any suitable paths, such as wired paths, cable paths, fiber-optic paths, satellite paths, a combination of such paths, etc.

Another example of an interactive television application is a home banking application. A home banking service may be supported using personnel at facilities such as service provider 50. An interactive home banking application that is implemented using the user equipment may access the home banking service via television distribution facility 14 and communications path 52 or via communications network 34 and communications path 54.

If desired, an interactive television application such as a video-on-demand application may be supported using server 56. Videos may be stored on server 56 and provided to the user equipment when requested by users.

If desired, applications such as the interactive television program guide application, a home shopping application, a home banking application, a video-on-demand application, and other applications (e.g., applications related to e-mail and chat or other communications functions, etc.) may be provided as separate applications that are accessed through a navigation shell application (i.e., a menu application with menu options corresponding to the applications). The features of such applications may be combined. For example, video-on-demand, home shopping, and communications functions may be incorporated into the program guide.

Moreover, the interactive television program guide application, the home banking application, and the home shopping application, the video-on-demand application, the communications application, and the navigation shell application, are only a few illustrative examples of the types of interactive television applications that may be supported by system 10. Other suitable applications that may be supported include, news services, Internet services, interactive wagering services (e.g., for wagering on horse races and the like), communications services (e.g., e-mail, chat, etc.), and any other suitable interactive applications.

These applications may be implemented locally on the user equipment. The applications may also be implemented using a client-server architecture in which the user equipment serves as a client processor and a server such as server 56 at television distribution facility 14 or other suitable location acts as a server processor. Other distributed architectures may also be used if desired. Regardless of the particular arrangement used to implement interactive television features related to program guides, home shopping, home banking, video-on-demand, Internet, communications, etc., the software that supports these features may be referred to as an application.

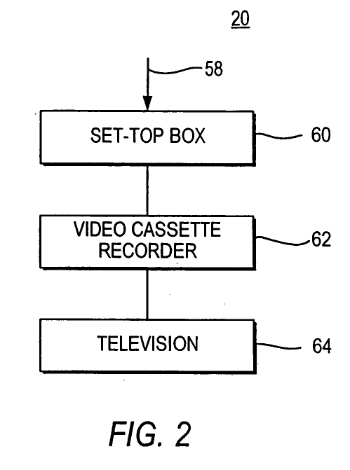

Illustrative user television equipment 20 that is based on a set-top box arrangement is shown in FIG. 2. Input/output 58 may be connected to communications paths such as paths 27 and 46. Television programming and other information may be received using input/output 58. Commands and requests and other information from the user may also be transmitted over input/output 58.

Set-top box 60 may be any suitable analog or digital set-top box. Set-top box 60 may contain an analog tuner for tuning to a desired analog television channel. Set-top box 60 may also contain digital decoding circuitry for receiving digital television and music channels. Both analog and digital channels may be handled together if desired. Set-top box 60 also contains a processor (e.g., a microcontroller or microprocessor or the like) that is used to execute software applications. Set-top box 60 may contain memory such as random-access memory for use when executing applications. Nonvolatile memory may also be used (e.g., to launch a boot-up routine and other instructions). Hard disk storage may be used to back up data and to otherwise support larger databases than may be supported using random-access memory approaches.

Set-top box 60 may have infrared (IR) or other communications circuitry for communicating with a remote control or wireless keyboard. Set-top box 60 may also have dedicated buttons and a front-panel display. The front-panel display may, for example, be used to display the current channel to which the set-top box is tuned.

Set-top box 60 may also have communications circuitry such as a cable modem, an integrated services digital network (ISDN) modem, a digital subscriber line (DSL) modem, a telephone modem, etc. for communications with other equipment. Such communications may involve the Internet or any other suitable communications networks or paths. If desired, the components of set-top box 60 may be integrated into other user equipment (e.g., a television or videocassette recorder).

A videocassette recorder 62 or other suitable recording device may be connected to set-top box 60. This allows videos from set-top box 60 to be recorded. For example, if set-top box 60 is tuned to a given television channel, the video signal for that television channel may be passed to videocassette recorder 62 for recording on a videocassette. If desired, videocassette recorder functions such as start, stop, record, etc. may be controlled by set-top box 60. For example, set-top box 60 may control videocassette recorder 62 using infrared commands directed toward the remote control inputs of videocassette recorder 62.

The output of videocassette recorder 62 may be provided to television 64 for display to the user. If videocassette recorder 62 is not being used, the video signals from set-top box 58 may be provided directly to television 64. If desired, any suitable monitor may be used to display the video.

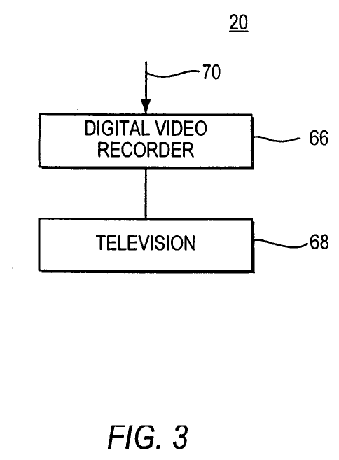

Another illustrative arrangement for user television equipment 20 is shown in FIG. 3. In the example of FIG. 3, user television equipment 20 includes a digital video recorder 66 (e.g., a personal video recorder (PVR)) and a television 68. Input/output 70 may be connected to communications paths such as paths 27 and 46. Television programming and other information may be received using input/output 70. Commands and requests and other information from the user may be transmitted over input/output 70.

Digital video recorder 66 may be similar to a standard set-top box, except that a hard disk or other suitable storage medium may be used for video storage in lieu of videocassettes. The hard disk may be internal to digital video recorder 66.

Digital video recorder 66 may contain an analog tuner for tuning to a desired analog television channel. Digital video recorder 66 may also contain digital decoding circuitry for receiving digital television and music channels. If desired, digital video recorder 66 may contain circuitry for handling both analog and digital channels. Digital video recorder 66 also contains a processor (e.g., a microcontroller or microprocessor or the like) that is used to execute software applications. Digital video recorder 66 may contain memory such as random-access memory for use when executing applications. Nonvolatile memory may also be used to store a boot-up routine or other instructions. The hard disk and other storage in digital video recorder 66 may be used to support databases (e.g., program guide databases or interactive television application databases).

Digital video recorder 66 may have IR communications circuitry or other suitable communications circuitry for communicating with a remote control. Digital video recorder 66 may also have dedicated buttons and a front-panel display. The front-panel display may, for example, be used to display the current channel to which the digital video recorder is tuned.

Digital video recorder 66 may also have communications circuitry such as a cable modem, an integrated services digital network (ISDN) modem, a digital subscriber line (DSL) modem, a telephone modem, etc. for communications with other equipment. Such communications may involve the Internet or any other suitable communications networks or paths.

If desired, digital video recorder 66 of FIG. 3 or set-top box 60 of FIG. 2 may be a satellite receiver or other equipment that has wireless communications circuitry for receiving satellite signals.

Television programming may be recorded on the hard disk of digital video recorder 66. Digital video recorder 66 may record new video while previously recorded video is being played back on television 68. This allows users to press a pause button during normal television viewing. When the pause button is pressed, the current television program is stored on the hard disk of digital video recorder 66. When the user presses play, the recorded video may be played back. This arrangement allows the user to seamlessly pause and resume television viewing.

The set-top box arrangement of FIG. 2 and the digital video recorder set-top box arrangement of FIG. 3 are merely illustrative. Other arrangements may be used if desired. For example, user television equipment may be based on a WebTV box, a personal computer television (PC/TV), or any other suitable television equipment arrangement. If desired, the functions of components such as set-top box 60, digital video recorder 66, a WebTV box, or PC/TV or the like may be integrated into a televison or personal computer or other suitable device.

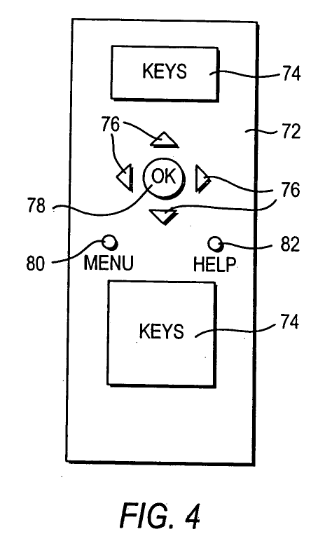

An illustrative remote control 72 for operating user television equipment 20 is shown in FIG. 4. Remote control 72 may have keys 74 such as channel up and down keys, a power on/off key, numeric keys, a favorites key (e.g., for setting favorites in a program guide application or other interactive television application), an info key (for requesting that additional information on a selection be displayed), etc. Arrow keys 76 may be used to position an on-screen cursor or highlight region on options of interest. Highlighted options may be selected using OK key 78. Menu key 80 may be used to direct an interactive television application (e.g., a program guide application, a nav shell application, or any other suitable application) to display a menu of available options.

Help key 82 may be used to invoke help functions such as context-sensitive on-screen help, etc.

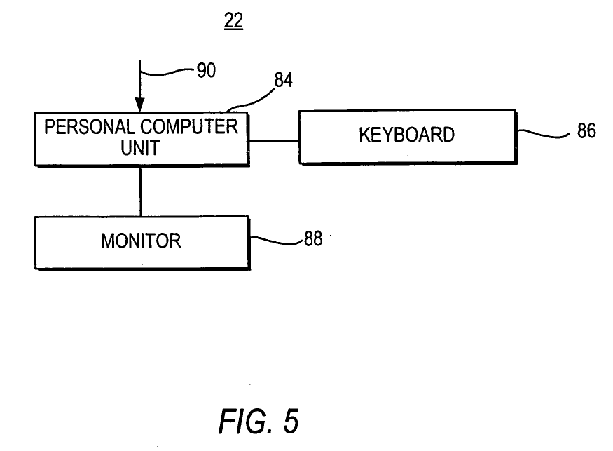

Illustrative user computer equipment 22 is shown in FIG. 5. In the arrangement of FIG. 5, personal computer 84 may be controlled by the user using keyboard 86 or other suitable user input device, such as a trackball, mouse, touch pad, touch screen, voice recognition system, etc. Television programming and interactive television application content may be displayed on monitor 88. Television programming and other information may be received from paths 28 and 48 (FIG. 1) using input/output 90. The user may also send commands and other information to remote services over input/output line 90.

Personal computer unit 84 may contain a television tuner card for decoding analog and digital television channels. The television tuner card may contain an analog tuner for tuning to a given analog channel and digital decoding circuitry for filtering out a desired digital television or music channel from a packetized digital data stream.

The user computer equipment arrangement of FIG. 5 is merely illustrative. Any suitable computer equipment arrangement may be used if desired.

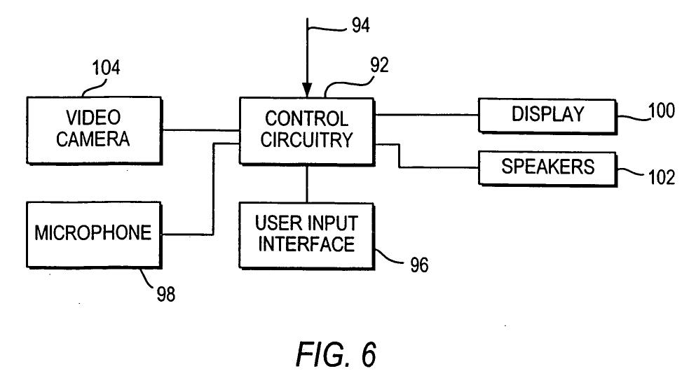

Moreover, the user television equipment and user computer equipment arrangements described above are merely illustrative. A more generalized embodiment of illustrative user equipment is shown in FIG. 6.

As shown in FIG. 6, control circuitry 92 is connected to input/output 94. Input/output 94 may be connected to communications paths such as paths 26, 27, 28, 42, 46, and 48 of FIG. 1. Television and music programming may be received via input/output 94 (e.g., from programming sources 12 and television distribution facility 14). Program scheduled information for an interactive television program guide may also be received via input/output 94. Input/output 94 may also be used to receive information for other interactive television applications. The user may use control circuitry 92 to send commands, requests, and other suitable information using input/output 94.

Control circuitry 94 may be based on any suitable processor such as a microprocessor, microcontroller, etc. Memory or other suitable storage devices may be provided as part of control circuitry 94. Tuning circuitry such as an analog tuner, an MPEG-2 decoder or other digital tuning circuitry, or any other suitable tuning circuits or combinations of such circuits may also be included as part of circuitry 92. The tuning circuitry may be used to tune the user equipment to a particular television or music channel (e.g., when it is desired to access a particular channel automatically upon turning on the user equipment).

Television programming and on-screen options and information may be displayed on display 100. Display 100 may be a monitor, a television, or any other suitable equipment for displaying visual images. Speakers 102 may be provided as part of a television or may be stand-alone units. Digital music and the audio component of videos displayed on display 100 may be played through speakers 102.

A user may control the control circuitry using user input interface 96. The user input interface may be any suitable user interface, such as a mouse, trackball, keypad, keyboard, touch screen, touch pad, or any other suitable user input interface. A microphone 98 and video camera 104 may be used to supply audio and video information to control circuitry 92.

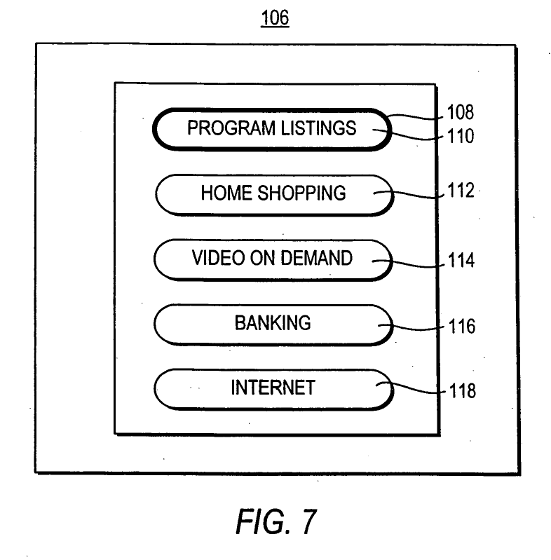

A user of user equipment 18 (e.g., a user of user television equipment or a user of user computer equipment, or a user of any other suitable user equipment device) may invoke an interactive television menu by pressing menu button 80 (FIG. 4). An illustrative interactive television navigation shell or menu 106 is shown in FIG. 7. Remote control 72 (FIG. 4) may be used to position highlight region 108 on top of options 110, 112, 114, 116, and 118. If the user selects option 110, a screen of program listings may be displayed. Option 112 may be used to invoke a home shopping application. Option 114 may be selected to display options related to video-on-demand services. If the user selects option 116, the user may be presented with an opportunity to access home banking functions. Selecting Internet option 118 may launch a web browser or the like.

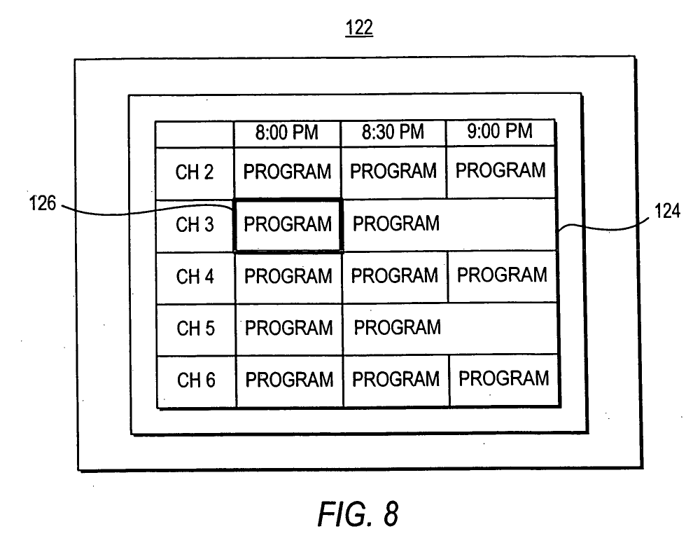

An illustrative program guide screen 122 that may be displayed for the user is shown in FIG. 8. Program guide screen 122 may be displayed, for example, when the user selects program listings option 108 of FIG. 7 or when the user selects a suitable option from within an interactive television program guide application. Program guide screen 122 may contain a grid or list of program listings 124. Program listings 124 may include program titles, channels, scheduled broadcast times, and any other suitable program schedule information. Advertisements may be displayed if desired.

A highlight region such as highlight region 126 may be used to select a desired program listing. If the user presses an OK key when a program listing for a current program is highlighted, the program guide may tune to the channel for that program. If the user presses an OK key when a program listing for a future program is highlighted, the program guide may provide the user with an opportunity to set a reminder for that program. Other functions that the program guide may provide include the ability to set favorites or establish preferences or other settings. For example, the user may select a particular channel for the program guide to automatically tune to when the user equipment is turned on. The user may also select favorite programs, favorite channels, etc. The program guide may provide the user with the ability to establish parental control settings, the ability to search for programming of interest, and the ability to view program descriptions, advertisements, text, graphics, and video, etc. These are merely illustrative examples of program guide functions that may be provided by an interactive television program application. Any other suitable program guide functions may be provided if desired. The program guide may be invoked from an option such as option 110 of FIG. 7, by pressing a dedicated guide button on a remote control, by selecting any other suitable button or on-screen option, etc.

When the user equipment is turned on by the user, the program guide may automatically tune the user equipment to an appropriate television channel. The turn-on television channel that is selected by the program guide may be based on the user's television viewing activities, the user's monitored interactions with the interactive television program guide application or other interactive television applications, or user-selected preference settings.

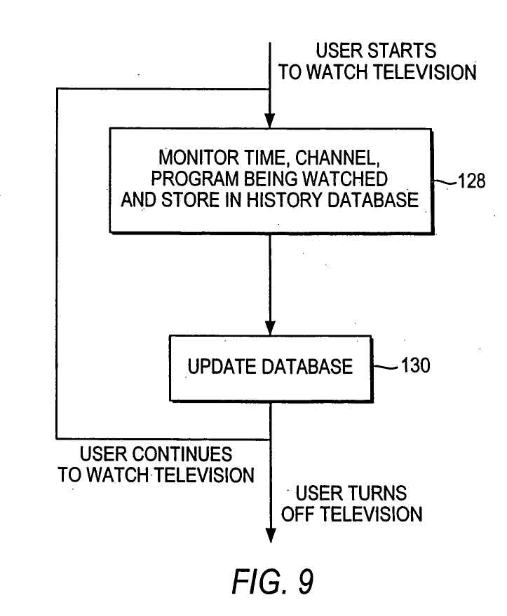

Illustrative steps involved in monitoring the user's viewing activities are shown in FIG. 9. At step 128, the interactive television program guide may monitor the time (e.g., using a clock implemented using control circuitry 92 of FIG. 6). The program guide may also monitor the channels being watched by the user by determining which channels the user tunes to with the tuning circuitry in control circuitry 92 of FIG. 6. The program guide may determine which programs the user watches and the length of time those programs are watched by comparing the known time and channel information with the program schedule information provided from program listings source 30 of FIG. 1. The program guide may also monitor which program guide advertisements the user interacts with and other interactions and viewing activities. Information on the user's viewing activities may be stored in a database (e.g., a history database). The database may be maintained at the user equipment or at a remote location (e.g., on server 56 of FIG. 1).

The history database may be updated at step 130. If the user continues to watch television, the program guide may again monitor which program is being watched at step 128 and may again update the history database at step 130. If the user is finished watching television, the user may turn off the user equipment.

By monitoring which programs the user watches, the program guide may detect certain viewing patterns. For example, the program guide may determine that the user nearly always tunes the television to a particular news channel at 6:00 PM on weeknights. As another example, the program guide might determine that the user tunes to a particular program on Thursday nights (e.g., the program “ER” at 9:00 on channel 6). The program guide may determine that the user has a habit of tuning to a particular channel whenever the user equipment is turned on. For example, the user may tune to the channel CNBC after the box is turned on. The program guide might also determine that the user frequently tunes to programs of certain genres (e.g., sports or news) when the user turns on the user equipment or during general television viewing. The user might often tune to programs containing a particular actor (either upon turning on the user equipment or at other times). These viewing habits may be ascertained by analyzing the data stored in the history database that is maintained by the program guide.

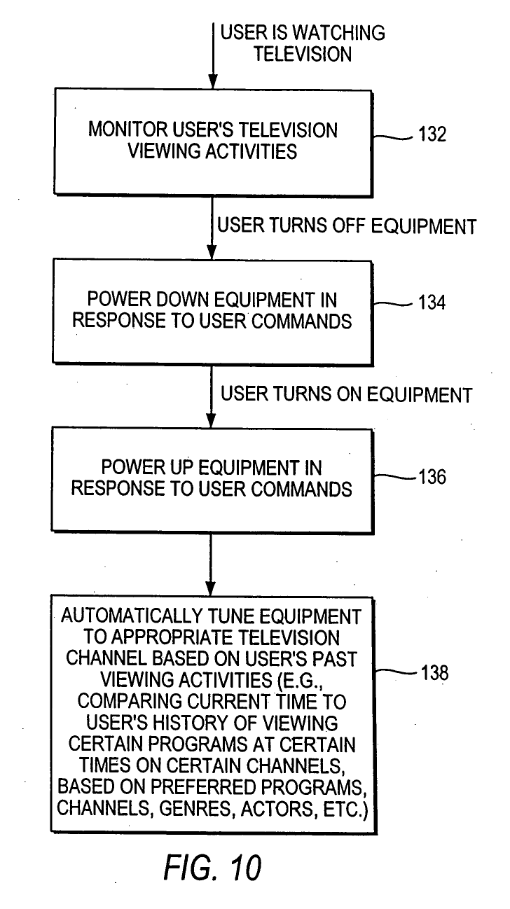

Illustrative steps involved in using information on the user's monitored television viewing activities to select the turn-on channel for the user equipment are shown in FIG. 10. At step 132, the program guide may monitor the user's viewing activities to detect patterns in the user's television viewing habits. For example, the program guide may determine what types of programs the user watches, which programs the user watches, the genres and actors for the programs that the user watches and other program-related information, etc.

At step 134, when the user presses a remote control power key or presses a switch), the user equipment may be turned off. At step 136, when the user turns on the equipment (e.g., by pressing a remote control power key or by turning on a switch), the user equipment may be turned on.

At step 138, upon turning on the user equipment, the program guide may automatically tune to an appropriate television channel based on the user's viewing habits. For example, if it is currently 9:20 PM, and the user typically watches ER on channel 6 from 9:00-9:30 PM, the program guide may automatically tune the tuning circuitry in control circuitry 92 of FIG. 6 to channel 6.

If the user tuned to CNBC upon turning on the user equipment the last time the user equipment was used, the program guide may automatically tune to CNBC. The program guide may continue to tune the user equipment to CNBC upon turning on the user equipment until the program guide detects another pattern in the user's turn-on preferences (e.g., the user tunes to TBS upon turning on the user equipment three times in a row). If desired, the program guide may always tune to the channel that the user initially watched upon turning on the user equipment (e.g., the channel that the user watched for more than 10 minutes or other suitable threshold duration).

If desired, the program guide may automatically tune to the channel that the user watches most often.

The program guide may tune based on the user's preferred genre of programming. For example, if the user typically watches news programs in the morning and sports programming in the evening, the program guide may automatically tune the user equipment to a news program when the user equipment is turned on in the morning and may automatically tune the user equipment to a sports program when the user equipment is turned on in the evening.

As the user's viewing habits change over time, the history database may be updated. The updating process may be done on a day-to-day basis or any over any other suitable time period. If desired, the updating may be done slowly over a period of days or weeks, so that an occasional departure from the user's normal habits will not skew the program guide's prediction of the best channel to tune to upon turning on the user equipment.

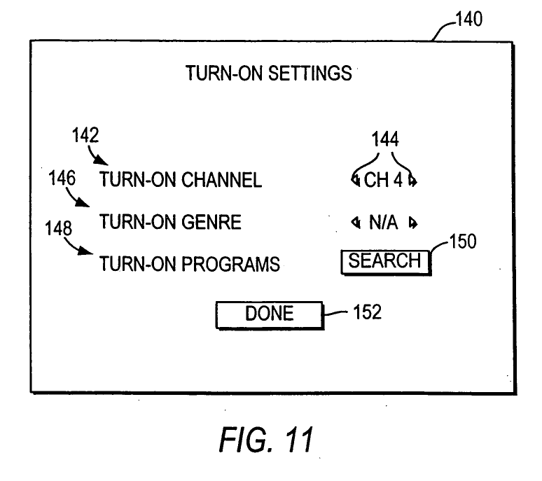

If desired, the user may adjust settings in the program guide that the program guide may use when determining which channel to automatically tune to upon turning on the user equipment. An illustrative turn-on channel settings screen 140 that the program guide may provide for the user is shown in FIG. 11.

Screen 140 of FIG. 11 may be used to provide the user with an opportunity to select a particular turn-on channel for the program guide to use. For example, a turn-on channel option 142 may be provided. As indicated by arrows 144, the user may select a desired turn-on channel from a list of the television channels that the user's equipment is capable of receiving. Right and left remote control arrow keys and an OK key may be used to make a selection.

Screen 140 of FIG. 11 may also be used to provide the user with an opportunity to specify a preferred genre for the program guide to use in choosing the turn-on channel. For example, a turn-on genre option 146 may be provided. Option 146 may allow the user to select a favorite genre of programming that the user desires to view when the user equipment is first turned on. For example, option 146 may allow the user to select from genres such as movies, sports, children's programming, news, documentaries, comedy, etc. When the user turns on the user equipment, the program guide may determine which (if any) of the television programs currently being received by the user equipment falls into the user's preferred genre. The program guide may then automatically tune the channel for that program.

Screen 140 may contain an option such as option 148 that allows the user to specify one or more turn-on program preferences. Option 148 may allow the user to identify programs to add to the user's turn-on channel program list by using search button 150. If the user clicks on search button 150, the user may be provided with an on-screen interface that allows the user to search for a desired program by entering letters from the program's title, using a search based on keywords, by specifying one or more genres of interest, by entering a time and day and selecting a desired program from a grid or list, or using any other suitable program-selection interface.

In the example of FIG. 11, the user has specified a particular turn-on channel. Accordingly, options 146 and 148 need not be used. If the user specifies one or more desired turn-on programs, however, none of the turn-on programs may be on the air when the user turns on the user equipment. The user may therefore also select a desired turn-on genre. If a selected turn-on program is being aired when the user turns on the user equipment, the program guide may tune to the channel for that program. If none of the selected turn-on programs are available, the program guide may use the user's specified genre of interest to identify a currently-airing program in that genre from the program schedule database. The program guide may then tune to the channel for that program.

If desired, the user may select a genre for the program guide to use when turning on the user equipment without selecting a turn-on program.

The user may select done option 152 when the user has finished adjusting the turn-on settings with screen 140.

The turn-on settings of FIG. 11 are merely illustrative. Any suitable user-adjusted settings may be used to specify how the program guide is to select a channel to automatically tune to when the user equipment is turned on.

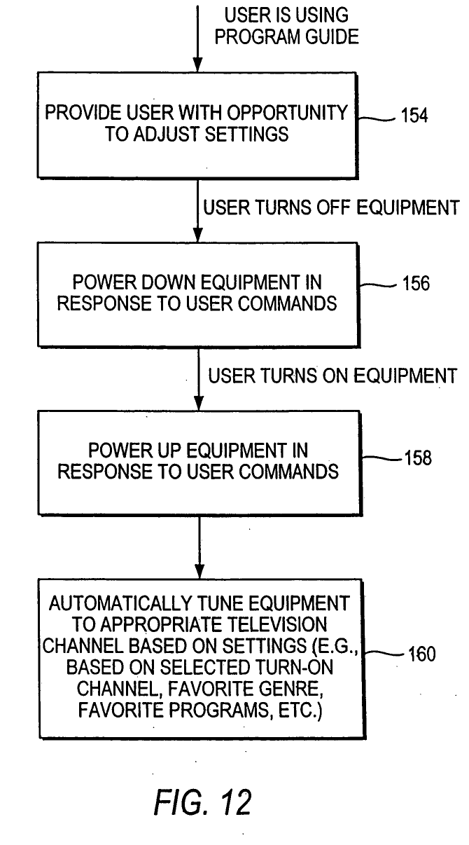

Illustrative steps involved in using user settings when automatically tuning the user equipment upon turning on the user equipment are shown in FIG. 12. At step 154, the interactive television program guide may provide the user with an opportunity to adjust settings such as channel turn-on settings. For example, the program guide may provide the user with on-screen options such as the on-screen options provided on screen 140 of FIG. 11.

When the user presses an appropriate remote control power button or the like, the user equipment may be turned off at step 156. When the user subsequently presses an appropriate remote control power button or the like, the user equipment may be turned on at step 158.

At step 160, upon the turning on of the user equipment, the program guide may automatically tune the user equipment to an appropriate television channel based on the settings (e.g., based on a selected turn-on channel, favorite genre, favorite programs, etc.) previously selected by the user.

If desired, the program guide may determine an appropriate turn-on channel based on the user's interactions with the interactive television program guide. For example, if the user often searches for program listings in the news genre, the program guide may determine that the user is interested in news-related programming. Upon turning on the user equipment, the program guide may automatically tune the user equipment to a news program.

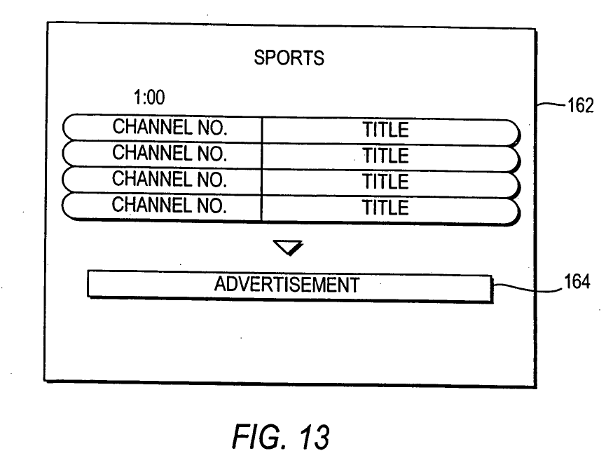

An illustrative program guide screen 162 that the program guide may display for the user is shown in FIG. 13. In the example of FIG. 13, the user has directed the program guide to display program listings in the sports category. If the user frequently accesses screen 162, the program guide may conclude that the user is interested in sports-related programming. Similar genre-based searches may be performed for other genres and for actors, programs, channels, etc. This information may be used by the program guide to determine the user's interests. For example, if the user often searches for news in the morning and sports in the evening, the program guide may automatically tune the user equipment to a news program if the user equipment is turned on in the morning and a sports program if the user equipment is turned on in the evening. If the user selects advertisements such as advertisement 164 that are related to comedies, the program guide may automatically tune the user equipment to a comedy program when it is turned on. These are merely illustrative examples. Any suitable information regarding the user's interactions with the program guide may be used by the program guide to select an appropriate turn-on channel.

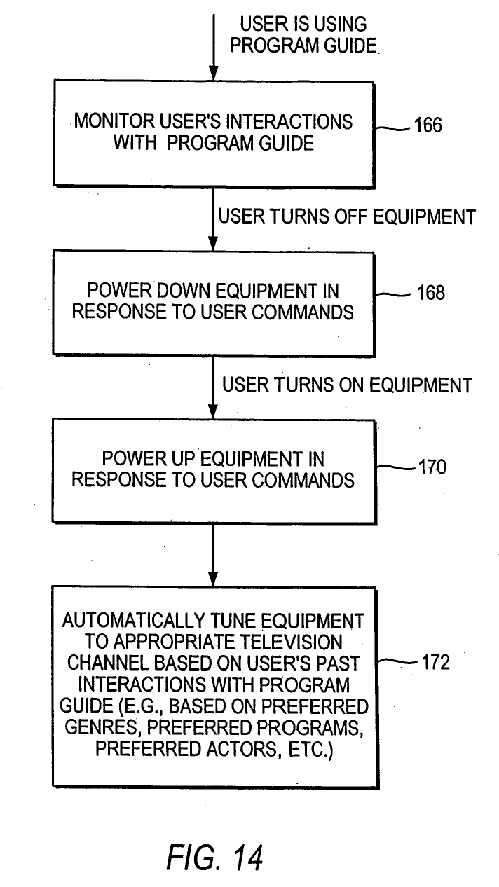

Illustrative steps involved in automatically tuning the user equipment to a television channel that is selected based on the user's interactions with the interactive television program guide are shown in FIG. 14.

At step 166, once the user is using the program guide, the program guide may monitor the user's interactions with the program guide. For example, the user's most-frequently selected genres may be monitored. Information on the user's interactions with the program guide may be stored in a history database. The history database may be maintained locally on user equipment 18 (FIG. 1) or remotely on a server such as server 56 (FIG. 1) or on any other suitable computing equipment. The history database that is used to store information on the user's interactions with the program guide may be the same history database that is used to maintain information on the user's viewing habits or may be a different database.

At step 168, when the user presses an appropriate remote control power button or the like, the user equipment may be turned off. At step 170, when the user presses a remote control power button or the like, the user equipment may be turned on.

Upon turning on the user equipment, the program guide may automatically tune the user equipment to an appropriate turn-on channel at step 172. The turn-on channel may be based on information on the user's interactions with the program guide that is maintained in the history database. For example, information regarding preferred programs, channels, and genres that has been gathered through the user's interactions with the guide may be used to select the turn-on channel.

If desired, the user's interactions with other interactive television applications (e.g., a video-on-demand application, a home shopping application, a banking application, a communications application, a navigation shell application, or other such applications) may also be monitored and this information used to select the turn-on channel. For example, if the user often uses the home shopping application, the user equipment may be tuned to a home shopping television channel upon turning on the user equipment. If the user often invokes the banking application, the user equipment may be tuned to a financial news television channel upon turning on the user equipment. These are merely illustrative examples. Any suitable information about the user's interactions with the interactive television applications may be used to determine which channel to tune to upon turning on the user equipment if desired.

The program guide may monitor the television viewing habits of the user and the user's interactions with the program guide and may be responsive to user-adjusted settings. If desired, the program guide or other application may determine an appropriate turn-on channel based on one or more or all of these criteria in any suitable combination. For example, the program guide may determine an appropriate turn-on channel based on both the television viewing habits of the user and user-adjusted program guide settings.

If desired, the user's interests in music may be used to determine an appropriate turn-on channel to use when the user equipment is turned on. Digital music channels may be provided by the program guide. Such digital music channels may be accessed by the user as part of the normal channel-tuning sequence. For example, digital music channels may be assigned channel numbers 400-420.

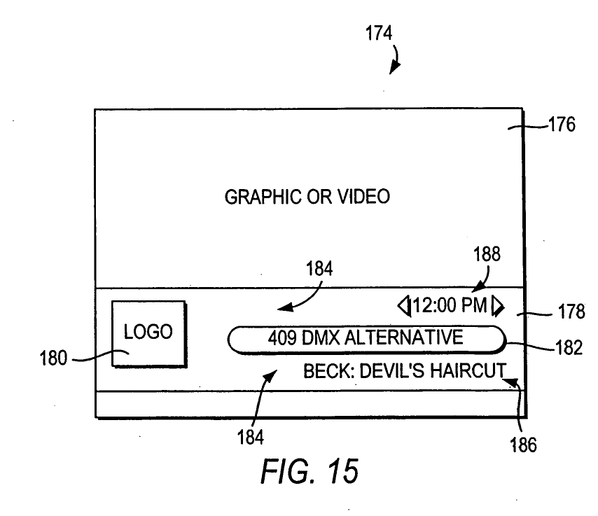

The user may use the interactive television program guide to search for desired music by channel, by music genre, etc. The user may also use a remote control or other suitable user interface to tune to a desired digital music channel. An illustrative digital music channel arrangement is shown in FIG. 15. Screen 174 may contain video for a current television program or a graphic in region 176. If the user is tuned to a television channel, the information in region 176 may be the current program on that channel. If the user is tuned to a digital music channel, the information in region 176 may be a graphic related to the song being played for the user.

An overlay or other information region 178 may be provided that contains information on a digital music channel. The information may or may not be synchronized with the information in region 176. With one suitable approach, each time the user presses an up or down channel key on a remote control or the like, the current channel changes and the information in regions 176 and 178 changes in synchronization. Each time the user presses an up or down arrow key, the information in region 176 remains the same, whereas the information in region 178 changes to reflect the newly-selected channel of interest.

Region 178 may contain a logo or other promotional information 180. Information 182 may be provided on the current digital music channel (if the channel is a music channel) or current television channel (if the channel is a television channel). Information 182 may contain information on the current song or television program being provided on that channel.

As indicated by arrows 184, the user may access information for adjacent channels by using up and down remote control arrow keys or the like. Information 186 may be provided on the title of the televison program on the selected channel (if the channel described in region 182 is a television channel) or the title of the song on the selected channel (if the channel described in region 182 is a music channel). Information 188 on the time may also be provided in region 178.

When the user locates a digital music channel of interest, the user may press an OK or enter or select key on the remote control or may otherwise indicate an interest in the content described in region 178. This directs the program guide to tune to the appropriate channel.

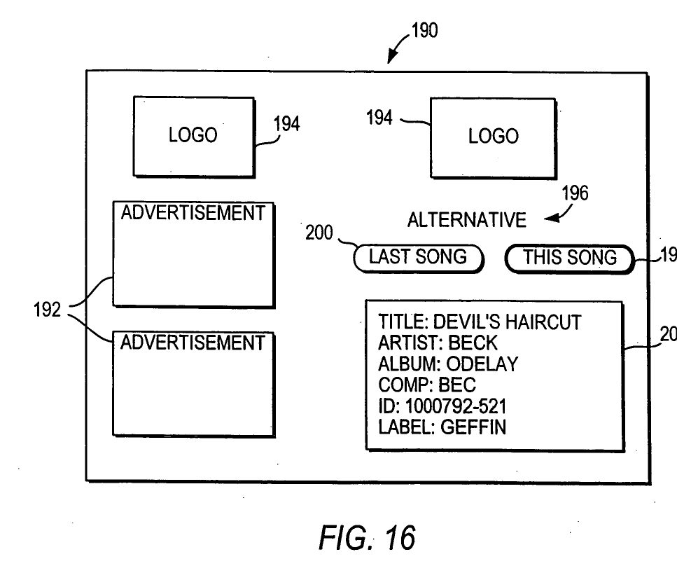

The program guide may then display a screen such as screen 190 of FIG. 16 on the display of the user equipment and may play corresponding music through speakers 102 (FIG. 6). Screen 190 may contain promotional material such as interactive advertisements 192 and logos 194. Information 196 may be provided on the current music channel. The user may navigate highlight region 198 to option 200 and press enter to obtain information on the last song played on the music channel. If the user selects the “this song” option highlighted in the example of FIG. 16, information 202 may be display on the current music selection being provided by the program guide. Information 202 may contain, for example, the title of the current song being played and information on the artist, album, and other information associated with the song.

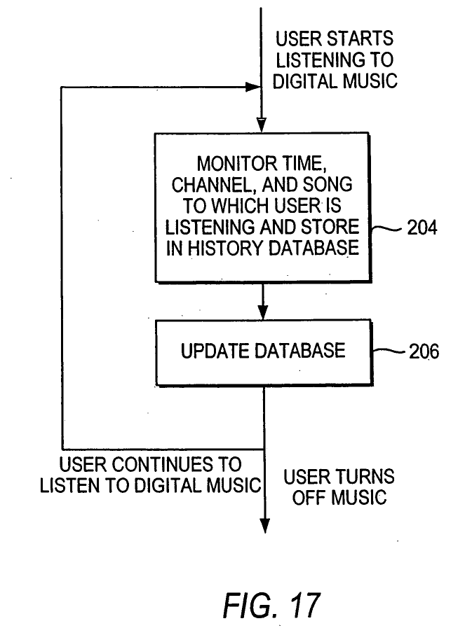

Illustrative steps involved in monitoring the user's music listening habits are shown in FIG. 17. At step 204, the program guide or other application may monitor the time, digital music channel, and song to which the user is listening.

This information may be stored in the history database at step 206. The history database in which music-related information is stored may be the same database as the history database used to store television-related information or may be a separate database. If the user continues to listen to music, the program guide may again monitor which song is being listened to at step 204 and may again update the history database at step 206. If the user is finished listening to music, the user may turn off the user equipment.

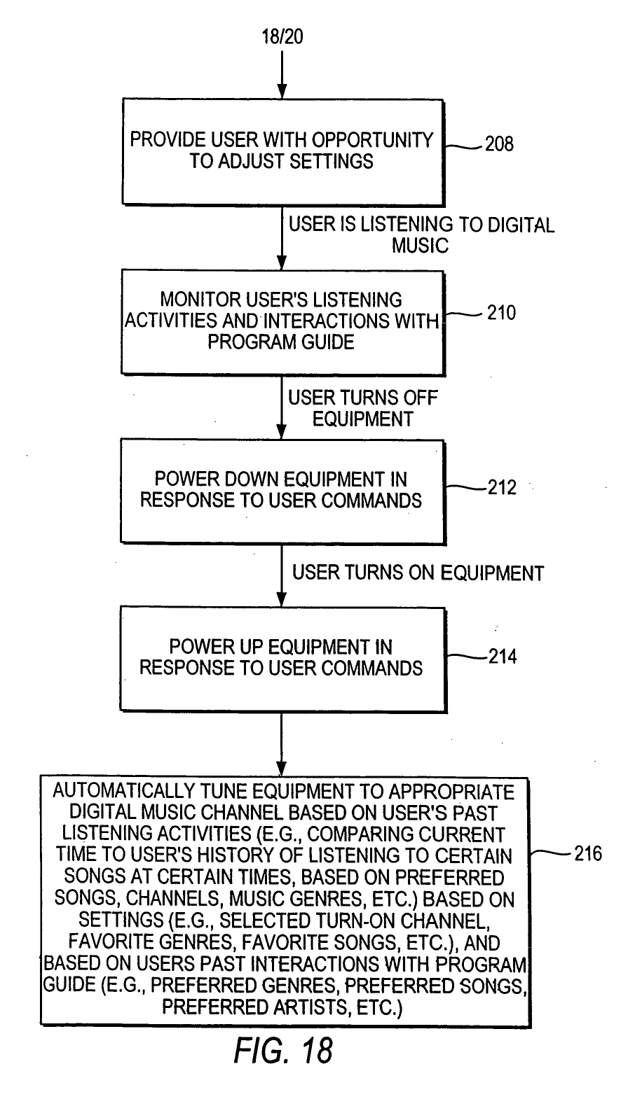

Illustrative steps involved in using information on the user's music interests to select the turn-on channel for the user equipment are shown in FIG. 18. At step 208, the user may be provided with an opportunity to adjust settings in the program guide. For example, the program guide may present the user with a turn-on channel settings screen that the user may use to select a desired digital music channel or genre of music that the user would like the program guide to use in selecting the turn-on channel.

At step 210, the program guide may monitor the user's listening activities to detect patterns in the user's television viewing habits. For example, the program guide may determine what types of songs (e.g., which musical genres) the user listens to, which particular songs the user listens to, the artists of the songs the user listens to, when the user listens to certain songs, and other music-related information. The program guide may also monitor the user's music-related interactions and other interactions with the program guide. For example, if the user purchases an album for a particular artist using a program guide shopping feature or a home shopping application, the program guide may determine that the user is interested in music by that artist. If the user searches for music channels providing classic rock music, the program guide may determine that the user is interested in classic rock, etc.

At step 212, when the user presses a remote control power key or presses a switch or the like, the user equipment may be turned off. At step 214, when the user presses a remote control power key or a switch or the like, the user equipment may be turned on.

At step 216, upon turning on the user equipment, the program guide may automatically tune to an appropriate digital music channel based on the user's music interests. The program guide may select the turn-on channel based on the user's listening activities, settings selected by the user, or the user's interactions with the interactive television program guide. As an example, if it is currently 9:20 PM, and the user typically listens to DMX 209 in the evening, the program guide may automatically tune the tuning circuitry in control circuitry 92 of FIG. 6 to channel 209, so that the user may listen to music on DMX channel 209.

If the user tuned to digital music channel DMX 209 upon turning on the user equipment the last time the user equipment was used, the program guide may automatically tune to digital music channel DMX 209. The program guide may continue to tune the user equipment to DMX 209 upon turning on the user equipment until the program guide detects another pattern in the user's turn-on preferences (e.g., the user tunes to DMX 208 or TBS upon turning on the user equipment three times in a row). If desired, the program guide may always tune to the music channel that the user initially listened to upon turning on the user equipment (e.g., the music channel that the user listened for more than 10 minutes or other suitable threshold duration).

If desired, the program guide may automatically tune to the music channel that the user listens to most often.

The program guide may tune based on the user's preferred genre of music. For example, if the user typically listens to rock music in the morning and classical programming in the evening, the program guide may automatically tune the user equipment to a rock digital music channel when the user equipment is turned on in the morning and may automatically tune the user equipment to a classical digital music channel when the user equipment is turned on in the evening.

As the user's listening habits change over time, the history database may be updated. The updating process may be done on a day-to-day basis or any over any other suitable time period. If desired, the updating may be done slowly over a period of days or weeks, so that an occasional departure from the user's normal listening habits will not skew the program guide's prediction of the best music channel to tune to upon turning on the user equipment.

The program guide may also automatically tune the user equipment to an appropriate digital music channel at step 216 based on user-selected settings (e.g., based on a selected turn-on channel, favorite music genre, favorite songs or artists, etc.) previously selected by the user.

If desired, the program guide may determine an appropriate turn-on music channel based on the user's interactions with the interactive television program guide. For example, if the user often searches for channels (music or television), content, or information related to rock music, the program guide may determine that the user is interested in the rock music genre. Upon turning on the user equipment, the program guide may automatically tune the user equipment to a digital music channel that provides rock music.

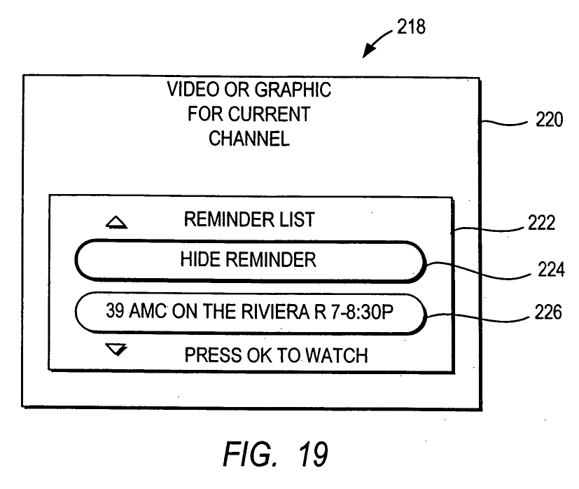

The information on the user's interests that is maintained in the history database may be used to provide targeted reminders to the user. An illustrative screen 218 that the program guide may display on the user equipment when providing reminders to the user is shown in FIG. 19. Screen 218 may have a content region 220. Content region 220 may contain video for a television program for a television channel to which the user equipment is currently tuned or may contain a graphic image for a song on a music channel to which the user equipment is currently tuned. Information region 222 may be used to display a list of one or more reminders. In the example of FIG. 19, an option 224 is included in region 222 that the user may choose to cancel the display of region 222. If the user highlights program listing 226 and presses a remote control OK button, the program guide may automatically tune the user to the channel associated with listing 226 (e.g., channel 39). The reminders provided in region 222 may be selected by the user or may be automatically selected by the program guide based at least in part on the information in the user's history database.

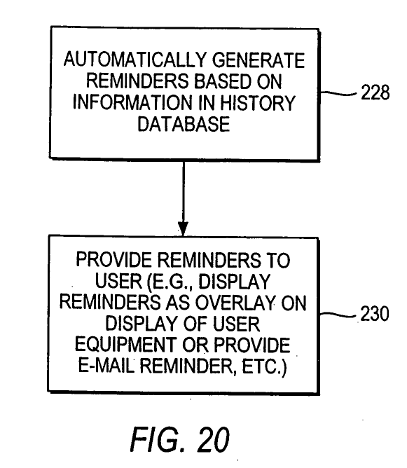

Illustrative steps involved in providing reminders based on the information in the history database are shown in FIG. 20. At step 228, the program guide may automatically generate reminders based on information in the history database. For example, the program guide may generate reminders for particular television programs based on information in the history database that indicates that the user is interested in a particular genre, series, movie title, actor, channel, etc.

At step 230, the reminders may be provided to the user. For example, just before (e.g., 5 minutes before) the scheduled broadcast time for a given television program, the program guide may display a pop-up overlay such as the information region 222 of FIG. 19 that contains a reminder for the given television program. The reminder may include information on the program's title, start time, channel, rating, etc.

If desired, the user's interactions with other interactive television applications or other interactive applications (e.g., music-related applications) may be used to determine the user's interests. Moreover, the television channel and music channel turn-on features may be provided by any suitable interactive television application, interactive music application, or any other suitable application.

The foregoing is merely illustrative of the principles of this invention and various modifications can be made by those skilled in the art without departing from the scope and spirit of the invention.

What is claimed is:

1-120. (canceled)

121. A method for using an interactive television program guide to automatically tune user equipment to a given digital music channel when the user equipment is turned on, comprising:
monitoring the music listening habits of the user with the interactive television program guide; and
using the interactive television program guide to automatically tune the user equipment to the given digital music channel in response to turning on the user equipment, wherein the given digital music channel is selected by the interactive television program guide based on the monitored music listening habits of the user.

122. The method defined in claim 121, wherein the user equipment includes a set-top box, the method further comprising using the interactive television program guide to tune the set-top box to the given digital music channel when the set-top box is turned on.

123. The method defined in claim 121, wherein the user equipment includes a digital video recorder, the method further comprising using the interactive television program guide to tune the digital video recorder to the given digital music channel when the digital video recorder is turned on.

124. The method defined in claim 121, wherein the user equipment includes a personal computer, the method further comprising using the interactive television program guide to tune the personal computer to the given digital music channel when the personal computer is turned on.

125. The method defined in claim 121 further comprising displaying an interactive menu on the user equipment that includes options that allow the user to invoke at least the interactive television program guide and a video-on-demand application.

126. (canceled)

127. The method defined in claim 121 wherein monitoring the music listening habits of the user comprises monitoring the music listening habits of the user by monitoring the time and by monitoring the channels tuned to by the user with the interactive television program guide.

128. The method defined in claim 121 wherein monitoring the music listening habits of the user comprises storing information on the music listening habits of the user in a history database.

129. The method defined in claim 121 wherein monitoring the music listening habits of the user comprises storing information on the music channels that the user listens to in a database.

130. The method defined in claim 121 wherein monitoring the music listening habits of the user comprises storing information on the music channels that the user equipment is tuned to when the user is listening to digital music and storing information on the times at which the user listens to those channels in a database on the user equipment.

131. The method defined in claim 121, wherein the user equipment is connected to a television distribution facility and wherein program listings data is provided from a program listings source, the method further comprising receiving the program listings data at the television distribution facility from the program listings source.

132-136. (canceled)

137. The method defined in claim 121 wherein using the interactive television program guide to automatically tune the user equipment to the given digital music channel in response to turning on the user equipment comprises using the interactive television program guide to automatically tune the user equipment to the given digital music channel based at least partially on the current time.

138. The method defined in claim 121 wherein the music listening habits of the user include listening to a preferred digital music channel and wherein using the interactive television program guide to automatically tune the user equipment to the given digital music channel in response to turning on the user equipment comprises using the interactive television program guide to automatically tune the user equipment to the preferred digital music channel when the user equipment is turned on.

139. The method defined in claim 121 wherein the music listening habits of the user include listening to a preferred music genre and wherein using the interactive television program guide to automatically tune the user equipment to the given digital music channel in response to turning on the user equipment comprises using the interactive television program guide to automatically tune the user equipment to a digital music channel that is playing programming in the preferred music genre when the user equipment is turned on.

140. The method defined in claim 121 further comprising monitoring the user's interactions with the interactive television program guide and using the interactive television program guide to automatically tune the user equipment to the given digital music channel based on the user's interactions with the interactive television program guide.

141. The method defined in claim 121 further comprising:
allowing the user to adjust settings in the interactive television program guide; and
using the interactive television program guide to automatically tune the user equipment to the given digital music channel based on at least some of the settings.

142. User equipment on which an interactive television program guide is implemented, comprising:
control circuitry;
a display; and
a user input interface, wherein the control circuitry, display, and user interface are configured to:
allow the interactive television program guide to display program listings on the display for a user;
monitor the music listening habits of the user with the interactive television program guide; and
allow the interactive television program guide to automatically tune the user equipment to a given digital music channel in response to turning on the user equipment, wherein the given television channel is selected by the interactive television program guide based on the monitored music listening habits of the user.

143. The user equipment defined in claim 142 wherein at least the control circuitry is part of a set-top box and wherein the interactive television program guide tunes the set-top box to the given digital music channel when the set-top box is turned on.

144. The user equipment defined in claim 142 wherein at least the control circuitry is part of a digital video recorder having a hard disk drive and wherein the interactive television program guide tunes the digital video recorder to the given digital music channel when the digital video recorder is turned on.

145. The user equipment defined in claim 142 wherein at least the control circuitry is part of a personal computer and wherein the interactive television program guide tunes to the given digital music channel when the personal computer is turned on.

146. The user equipment defined in claim 142 wherein the control circuitry, display, and user interface are further configured to display an interactive menu on the display that includes options that allow the user to use the user interface to invoke at least the interactive television program guide and a video-on-demand application.

147. (canceled)

148. The user equipment defined in claim 142 wherein the control circuitry, display, and user interface are further configured to monitor the music listening habits of the user by monitoring the time and by monitoring the channels tuned to by the user with the interactive television program guide.

149. The user equipment defined in claim 142 wherein the control circuitry, display, and user interface are further configured to monitor the music listening habits of the user by storing information on the music listening habits of the user in a history database.

150. The user equipment defined in claim 142 wherein the control circuitry, display, and user interface are further configured to monitor the music listening habits of the user by storing information on the digital music channels that the user watches in a database.

151. The user equipment defined in claim 142 wherein the control circuitry, display, and user interface are further configured to monitor the music listening habits of the user by storing information on the digital music channels that the user equipment is tuned to when the user is listening to music and by storing information on the times at which the user listens to those channels in a database on the user equipment.

152-157. (canceled)

158. The user equipment defined in claim 142 wherein the interactive television program guide automatically tunes the user equipment to the given digital music channel based at least partially on the current time.

159. The user equipment defined in claim 142 wherein the music listening habits of the user include listening to a preferred digital music channel and wherein the interactive television program guide automatically tunes the user equipment to the preferred digital music channel when the user equipment is turned on.

160. The user equipment defined in claim 142 wherein the music listening habits of the user include listening to a preferred music genre and wherein the interactive television program guide automatically tunes the user equipment to a digital music channel that is playing songs in the preferred music genre when the user equipment is turned on.

161. The user equipment defined in claim 142 wherein the control circuitry, display, and user interface are further configured to monitor the user's interactions with the interactive television program guide, wherein the interactive television program guide automatically tunes the user equipment to the given digital music channel based on the user's interactions with the interactive television program guide.

162. The user equipment defined in claim 142 wherein the control circuitry, display, and user interface are further configured to:
allow the user to adjust settings in the interactive television program guide; and
allow the interactive television program guide to automatically tune the user equipment to the given digital music channel based on at least some of the settings.
